(19) United States
(12) Patent Application Publication
(10) Pub. No.: US 2023/0267793 A1
(43) Pub. Date: Aug. 24, 2023

(54) Ice Cream Vending Machine

(71) Applicant: Maximilian M. Anziano, Corte Madera, CA (US)

(72) Inventor: Maximilian M. Anziano, Corte Madera, CA (US)

(21) Appl. No.: 18/183,945

(22) Filed: Mar. 14, 2023

Related U.S. Application Data
(63) Continuation-in-part of application No. 16/912,710, filed on Jun. 26, 2020, now Pat. No. 11,625,970.
Application No. 16/912,710 is a continuation-in-part of application No. 15/732,535, filed on Nov. 27, 2017, now Pat. No. 10,743,562.

(51) Int. Cl. G07F 13/10; A23G 9/28; A23G 9/22; G06Q 20/18

(52) U.S. Cl. CPC G07F 13/10; A23G 9/228; A23G 9/283; A23G 9/288; G06Q 20/18

(57) ABSTRACT

An improved interactive frozen confectionery vending machine with two alternate freezer enclosures storing a variety of ice creams in cups is presented. The vending machine further comprises a toppings dispensing and a control system enclosures. A programmable control system enables a customer to select one ice cream cup at a time of a flavor of his or her choide and customize the selected ice cream with a choice of automatically dispensed hard or soft toppings via a gear motor operated arm and flexible liquid topping delivery tubes. A Wi-Fi enabled payment system and an ice cream and topping selection are implemented via a touch screen. The vending machine interior is accessible by pre-authorized personnel only.

### CROSS REFERENCE TO RELATED APPLICATIONS

This application is a continuation-in-part of U.S. Pat. Application 16/912,710, filed Jun. 26, 2020, which claims priority to U.S. Pat. Application 15/732,535, filed Nov. 27, 2017. The entire contents of each priority document is incorporated herein by reference.

### STATEMENT REGARDING FEDERALLY SPONSORED RESEARCH OR DEVELOPMENT

Not Applicable.

### DESCRIPTION OF ATTACHED APPENDIX

Not Applicable.

### BACKGROUND OF THE INVENTION

This invention relates generally to the field of automated dispensing/vending machines and more specifically to an ice-cream and ice-cream topping vending machine.

In other aspects, this invention relates to an ice-cream dispensing/vending machine capable of interactively customize a selected ice-cream flavor with a selection of hard and/or soft toppings.

Automated machines for dispensing ice-cream and other frozen confectioneries are known in the art. For example, Chirnomas (US Pat. No 5,027,698) discloses an ice-cream vending machine wherein the machine dispenses pre-filled containers of ice-cream. Davis et al (U.S. Pat. Application 2000251270) describes an ice-cream dispensing machine for dispensing soft-serve ice-cream. Kateman et al (U.S. Pat. No 7,052,728) describes a machine for vending single servings of different flavors, wherein selected flavorants are mixed into a base liquid prior to freezing. Jones et al (U.S. Pat. No 7,896,038) discloses a confectionary vending machine that employs robotics to provide a customized frozen confection.

However, even though the above described devices deliver frozen confections in a somewhat custom manner, the instant invention improves on the prior technology. For example, in the Jones et al. patent, an expensive robotic arm moves an ice-cream receiving cup to one of a variety of topping holding stations to have soft serve ice-cream delivered into the cup and then topping applied to the soft serve ice-cream. There is no ability to dispense standard ice-cream which tends to be harder and not suitable for dispensing through a tube. Second, there is no provision for applying the toppings in an evenly distributed manner within the cup. Third, the robotic arm is required to travel to each topping dispensing location. A simpler and more economical solution is to improve to a design that has a radially disposed toppings delivered to a centrally located ice-cream cup. Fourth, the frozen confectionary is stored in the top portion of the vending machine, requiring the entire top portion of the machine to be kept at freezing temperatures thereby incurring extra expense to maintain low temperature in an uninsulated environment, plus the likely event of excess moisture creating ice partials that can attach to the transparent front surface which defeats the intended viewing experience of the user.

### BRIEF SUMMARY OF THE INSTANT INVENTION

The primary object of the instant invention is to provide an improved ice cream vending machine that uses a centralized gear motor to power an arm and attached cup to receive toppings from radially placed topping cannisters and deliver the toppings to an ice cream cup.

Another object of the instant invention is to provide an improved ice cream vending machine that uses a vertically oriented rotating arm to deliver liquid toppings to an ice cream cup.

Another object of the invention is to provide an improved ice cream vending machine that uses either a rotatable carousel structure to retain a plurality of stacked ice cream cups, or in another embodiment, wherein it uses a multi-shelf freezer storage wherein cups are stored in and dispensed from a gravity dispensing downward sloping shelves; and to lift a selected ice cream cup to a dispensing area for consuming as is or for further customization with user selectable toppings.

A further object of the invention is to provide an improved ice cream vending machine that uses a touch screen to allow users to select ice cream flavors and toppings.

Yet another object of the invention is to provide an improved ice cream vending machine that dispenses spoons for use by customers.

Still yet another object of the invention is to provide an improved ice cream vending machine that includes lockable hinged door panels to allow a person to easily refill the machine.

Another object of the invention is to provide an improved ice cream vending machine that includes a photographic quality display which cycles on and off to notify the user which liquid topping is being dispensed.

Another object of the invention is to provide an improved ice cream vending machine that includes an access to allow one cup of ice cream to be removed and then closes to prevent customers from reaching inside the machine.

Other objects and advantages of the present invention will become apparent from the following descriptions, taken in connection with the accompanying drawings, wherein, by way of illustration and example, the embodiments of the present invention are disclosed.

In accordance with preferred embodiments of the invention, there is disclosed an improved ice cream vending machine comprising: two alternate freezer enclosures, a toppings delivery enclosure, a control system, condenser and compressor enclosure, and a microcontroller based control system.

### BRIEF DESCRIPTION OF THE DRAWINGS

The drawings constitute a part of this specification and include exemplary embodiments to the instant invention, which may be embodied in various forms. It is to be understood that in some instances various aspects of the instant embodiments may be shown exaggerated or enlarged to facilitate an understanding of the instant embodiment.

FIG. 1 is a perspective view of the invention.

FIG. 2 is a front view of the invention.

FIG. 3 is a perspective view of the invention with freezer enclosure door opened.

FIG. 4 is a perspective view of the invention with dispenser enclosure door opened.

FIG. 5 is a section view showing an ice cream cup in position to receive toppings.

FIG. 6 is a section view showing the front rotating door in the open position.

FIG. 7 is a perspective view of the sliding cup retaining platform in the closed position.

FIG. 8 is a perspective view of the sliding cup retaining platform in the open position.

FIG. 9 is a perspective view of the rotating front door assembly in the open position.

FIG. 10 is a perspective view of the rotating front door assembly in the closed position.

FIG. 11 is a side section view of the freezer enclosure showing a stack of ice cream cups before they are lifted.

FIG. 12 is a side section view of the freezer enclosure showing a stack of ice cream cups being lifted halfway up.

FIG. 13 is a plan view looking down on the stacks of ice cream cups with the carousel.

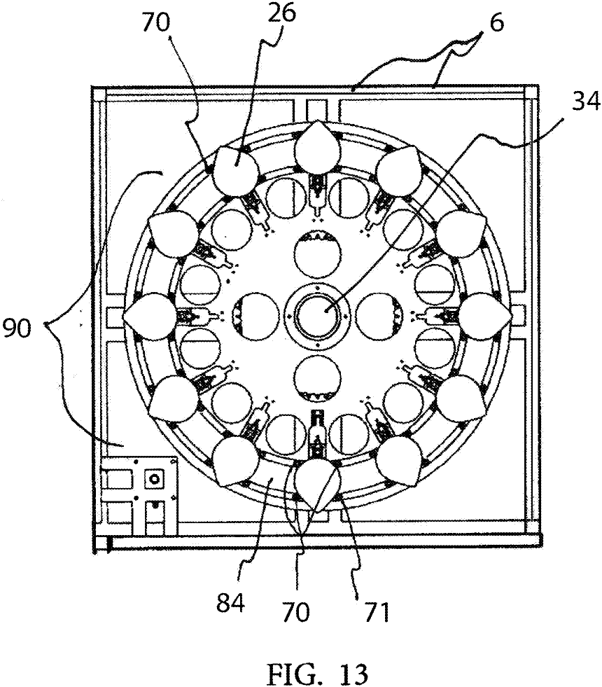

FIG. 14 is a partial perspective view showing the bottom portion of the carousel assembly.

FIG. 15 is a perspective view of an alternate freezer enclosure.

FIG. 16 is a side view of the shelves of the alternate freezer enclosure.

FIG. 17 is a view of one cup being released from a shelf.

FIG. 18 is a perspective view of the starting journey of one cup.

FIG. 19 is a perspective view of said cup rolling down a ramp.

FIG. 20 is a perspective view of said cup supported by the lift platform.

FIG. 21 is a perspective view of the lift platform and cup being lifted by a linear actuator,

FIG. 22 is a perspective view of the cup situated in the lower box.

FIG. 23 is a perspective view of the cup located in the upper box.

FIG. 24 is a perspective view of the cup and a portion of the upper box sliding to the central portion of the toppings dispensing area.

### DETAILED DESCRIPTION OF THE PREFERRED EMBODIMENTS

Detailed descriptions of the two preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

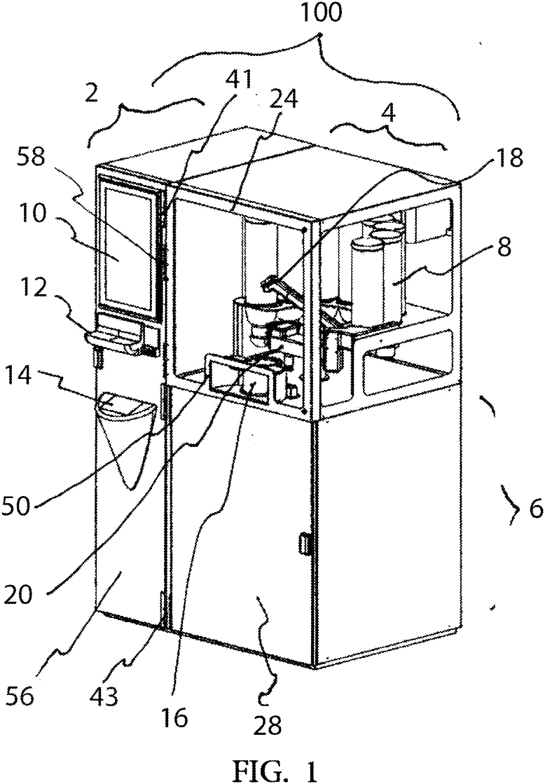

Referring now to FIG. 1, we see a perspective view of the interactive frozen confectionery vending machine 100. The interactive frozen confectionery vending machine 100 is made up of at least three major enclosures: the freezer enclosure 6, the delivery and toppings dispensing enclosure 4 and the support equipment enclosure 2. The front of each enclosure 2, 4, 6 includes a hinged door that is lockable via a standard lock assembly. The walls separating the enclosures 2, 4, 6 from each other comprise fittings and functional openings to facilitate interworking of equipment disposed in said enclosures. The front surface of the support equipment enclosure 2 includes a video display panel 10. The video display panel 10 can show animated images while the interactive frozen confectionery vending machine is in its initial waiting state, the images displaying preprogramed messages to a potential customer. An eating utensils dispenser 12 and a touch screen 14 are located just below the video display panel 10. The delivery and toppings dispensing enclosure 4 includes transparent panels on the front and side of the enclosure to allow a customer to view the toppings as the dispensing activity happens. A plurality of radially disposed hard topping canisters 8 can be accessed by a centrally rotating hard toppings dispenser arm 50. Liquid toppings are stored in the top rear portion of enclosure 2. The term liquid toppings or soft toppings are used interchangeably in the writing of the present specification; the liquid or soft toppings comprise all viscous fluid toppings.

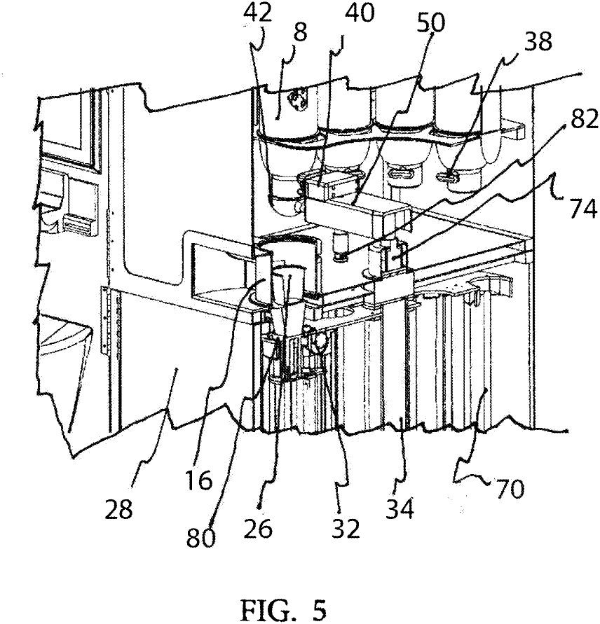

Front panel 28 of the freezer enclosure can open via hinges 43 to allow a service person to refill frozen confectionery cups that are stored within the freezer enclosure 6. Front door 24 of the delivery and toppings dispensing enclosure can open via hinges 41. Front panel 56 of support equipment enclosure can be opened via hinges 58. Rotatable customer access door 16 of the delivery and toppings dispensing enclosure 4 is opened and closed by the programable digital control system to allow a customer access to a purchased frozen confectionery cup as shown in the section view in FIG. 5. Touch screen 14 allows the customer to choose from multiple frozen confectionery flavors, the chosen frozen confectionery cup further customizable by the customer via the touch screen with selections from multiple hard topping choices and from multiple liquid topping choices. It will be apparent to those skilled in the art that the touch screen is a bidirectional customer machine information input and output interface, processing haptic inputs and visually displaying prompts and information. A programable digital processing unit, not shown, receives inputs from the touch screen and controls all functions, including but not limited to frozen confectionery cup lifting, hard and liquid toppings dispensing, rotatable customer access door opening and closing, and payment operations.

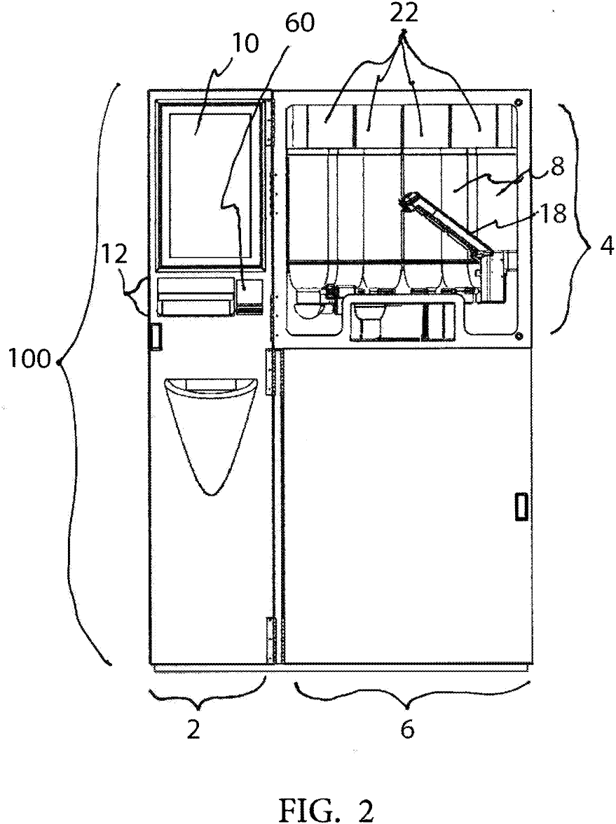

FIG. 2 is a front view of the invention 100. Photo panels 22 are back lit and show the flavors of four different liquid toppings. When a liquid topping is being dispensed by dispenser arm 18, The corresponding photo panel will light up intermittently to show the customer which topping is being delivered to the waiting ice cream cup 26 as shown in the section view in FIG. 5. Payment processing module 60 is accessible to the customer for paying for ice cream and toppings.

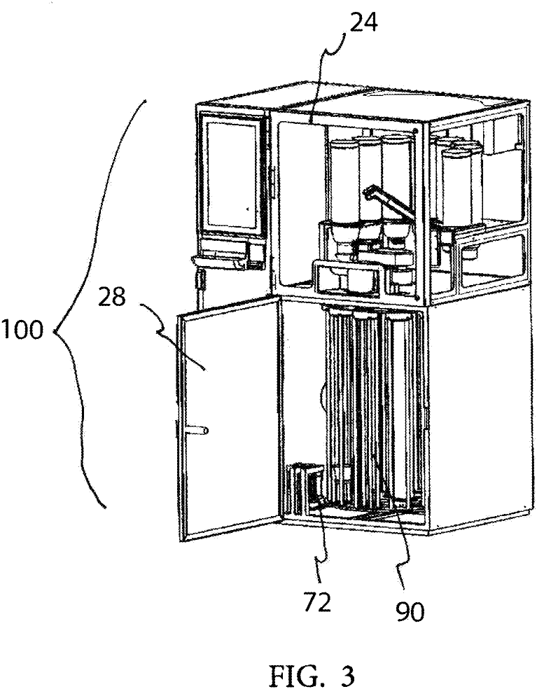

FIG. 3 is a perspective view of the invention with the freezer enclosure door in the open position revealing the carrousel assembly 70 which can be caused to rotate by stepper motor 72. The carrousel assembly 70 includes vertical rods that retain stacked ice cream cups. When a customer selects and ice cream flavor, the carrousel assembly rotates to the proper column of ice cream cups and lifts the column to the point where one ice cream cup 26 rises into the toppings dispensing enclosure as shown in the section view in FIG. 5.

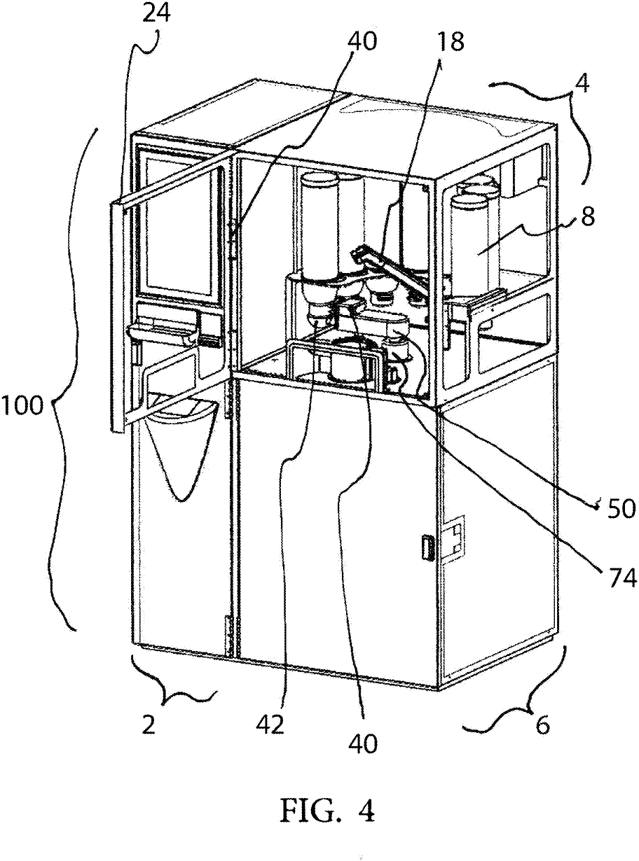

FIG. 4 is a perspective view of the invention 100 with the topping’s enclosure door 24 in the open position. Stepper motor 74 rotates dispenser arm 50 to the selected topping cannister 8. A servo motor 40 located on the front end of the arm 50 rotates a knob 38 as shown in FIG. 5, that causes a portion of topping to be dropped into a cup 42. The arm 50 can then be rotated until the cup 42 is directly over the ice cream cup 26. roller bearing 82 supports the arm 50 on the floor of the topping’s enclosure 4 to ensure that the arm retains its proper horizontal orientation. A servo motor within arm 50 can rotate the cup 42 one hundred and eighty degrees so that the portion of topping falls onto the top of the ice cream in cup 26. Liquid dispensing arm 18 can rotate vertically down to just above the ice cream cup 26 where one of four selected liquid toppings can be dispensed via pumps and liquid toppings containers located within the electronics enclosure. A flexible tube for each liquid topping extends from each pump to the tip of the liquid dispensing arm 18. Non-drip spring biased exit ports at the end of each tube prevent excess liquid from escaping during non-use periods. The lockable door 24 can be opened via hinges 40 to allow a service person to restock the hard topping cannisters 8.

FIG. 5 is a partial section view bisecting the freezer enclosure 6 and the delivery and toppings dispensing enclosure 4. A gear motor 32 coupled with a cable lifts a cup liftable platform 80 up until a frozen confectionery cup 26 enters the delivery and topping dispensing area. Each stack of frozen confectionery cups has its own cup liftable platform 80 that lifts each stack of frozen confectionery cups 26. Rotatable customer access door 16 is shown in the closed position, so that the customer cannot have access into the dispensing area when not granted access. Central tubular column 34 acts as a central rotation point for carousel assembly 90. Vertical rods are arranged in groups of at least four, three solid rods 70 and one spring biased rod 71, to trap stacks of frozen confectionery cups 26. One or more of the rods of the group are spring biased to allow it to be removed to reload a stack of frozen confectionery cups 26.

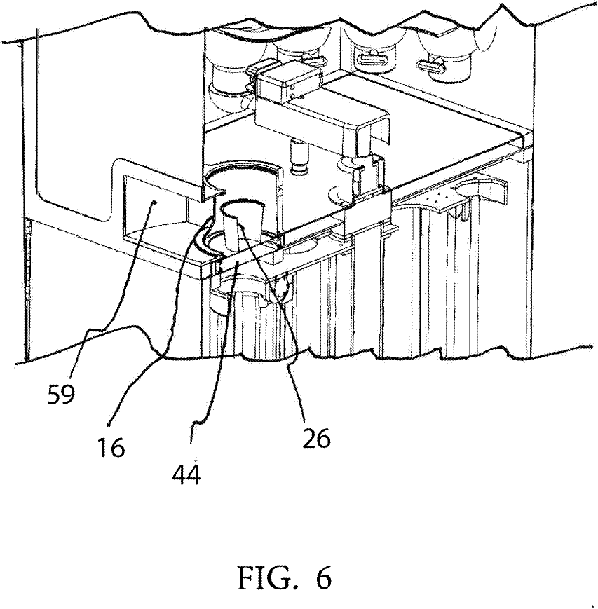

FIG. 6 is a partial section view of the invention showing the rotating front door 16 in the open position allowing a customer access to the ice cream cup 26 while the cup 26 is resting on sliding door 44. The sliding door 44 closes the aperture between the freezer enclosure 6 and the toppings enclosure 4 thereby eliminating the possibility of a customer from reaching down into the freezer enclosure 6 to grab an additional ice cream cup 26. The sliding door also keeps the aperture closed in between uses thereby restricting the exit of freezing air from the freezer enclosure 6.

Furthermore, FIG. 6 is showing the rotatable customer access door 16 in the open position allowing a customer access to the frozen confectionery cup 26 while the cup 26 is resting on slidable cup retaining platform 44. The slidable cup retaining platform 44 closes the aperture between the freezer enclosure 6 ceiling and the delivery and toppings dispensing enclosure 4 thereby eliminating the possibility of a customer from reaching down into the freezer enclosure 6 to grab an additional frozen confectionery cup 26. The slidable cup retaining platform also keeps the aperture closed in between uses thereby restricting the exit of freezing air from the freezer enclosure 6.

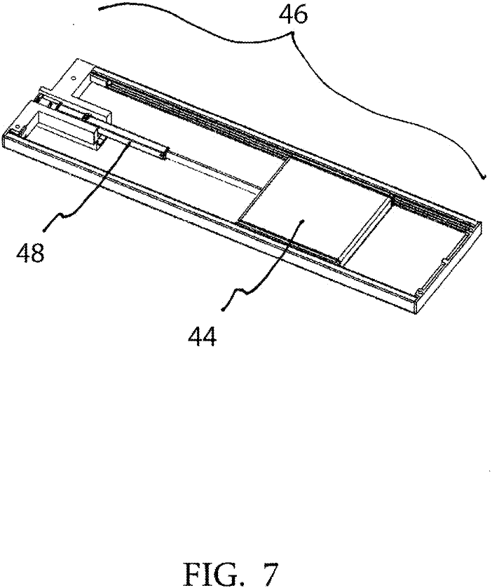

FIG. 7 is a perspective view of the sliding door assembly 46 with the sliding door 44 in the closed position.

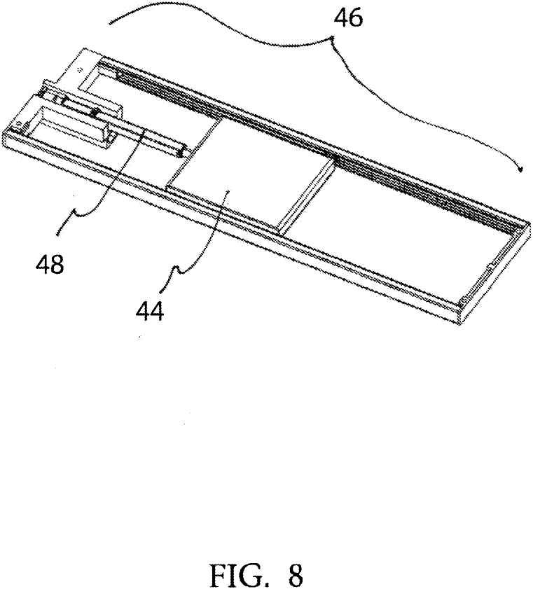

FIG. 8 is a perspective view of the sliding door assembly 46 with the sliding door 44 in the open position via linear actuator 48.

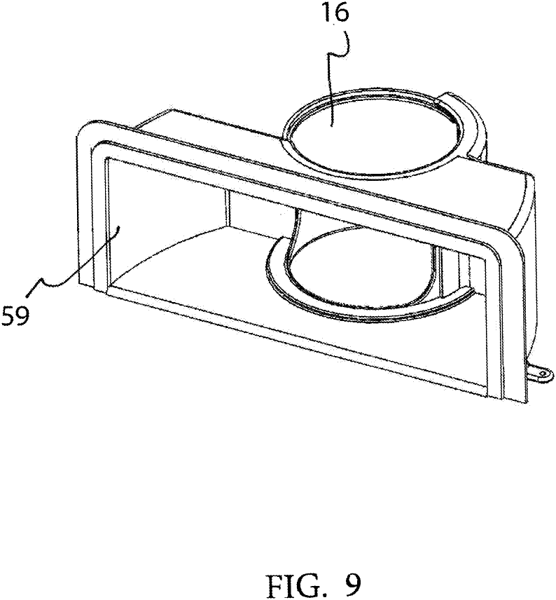

FIG. 9 is a perspective view of the front door surround 59 with the rotating front door 16 in the open position. The front door 16 includes a circular base that has gear teeth, not shown, around its perimeter. A gear motor, not shown, has a matching drive gear that engages the teeth of the rotating door 16 to allow it to revolve to an open position or a closed position.

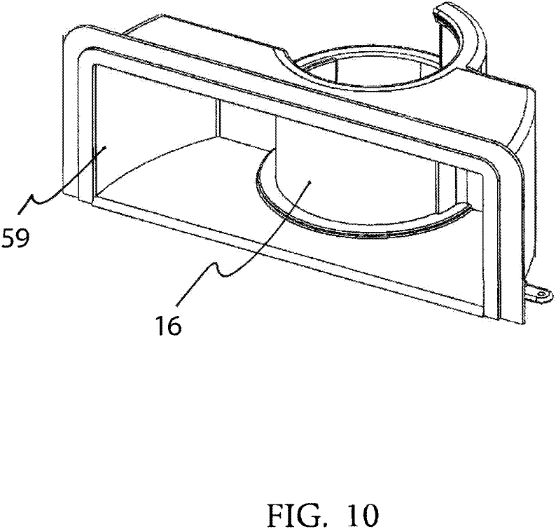

FIG. 10 is a perspective view of the front door surround 59 with the rotating front door 16 in the closed position.

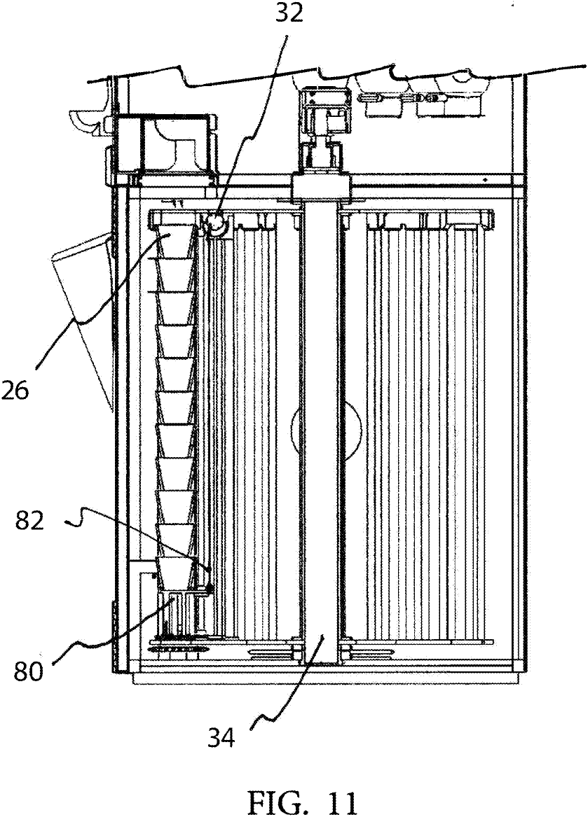

FIG. 11 is a side section view of the freezer enclosure 6 that shows a stack of ice cream cups 26 ready to be lifted by lift platform 80. The platform 80 is lifted by cable 82 that can be rolled up or let down by gear motor 32.

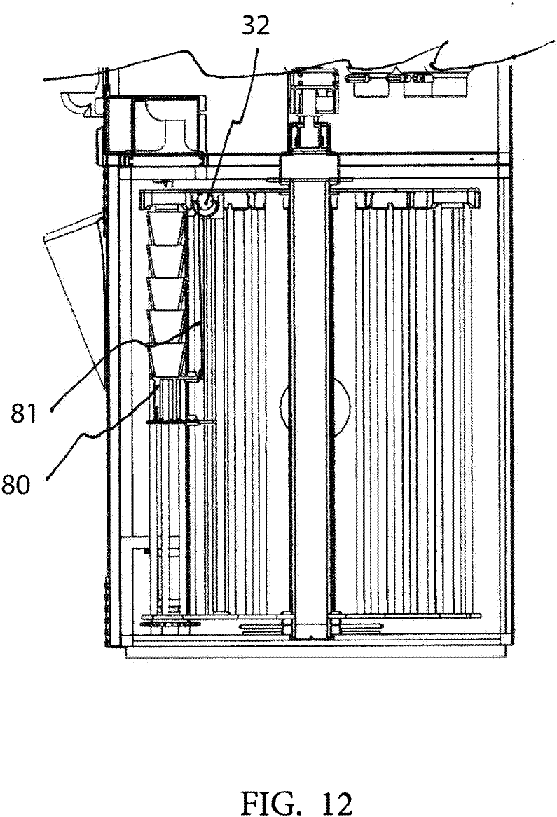

FIG. 12 is a side section view of the freezer enclosure 6 showing the stack of ice cream cups 26 lifted halfway up as ice cream is delivered the toppings enclosure area 4.

Figurer 13 is a plan view looking down on the stacks of ice cream cups 26 shown in a radial pattern on carousel base platform 84. In the embodiment shown, there are a total of twelve stacks of ice cream cups 26.

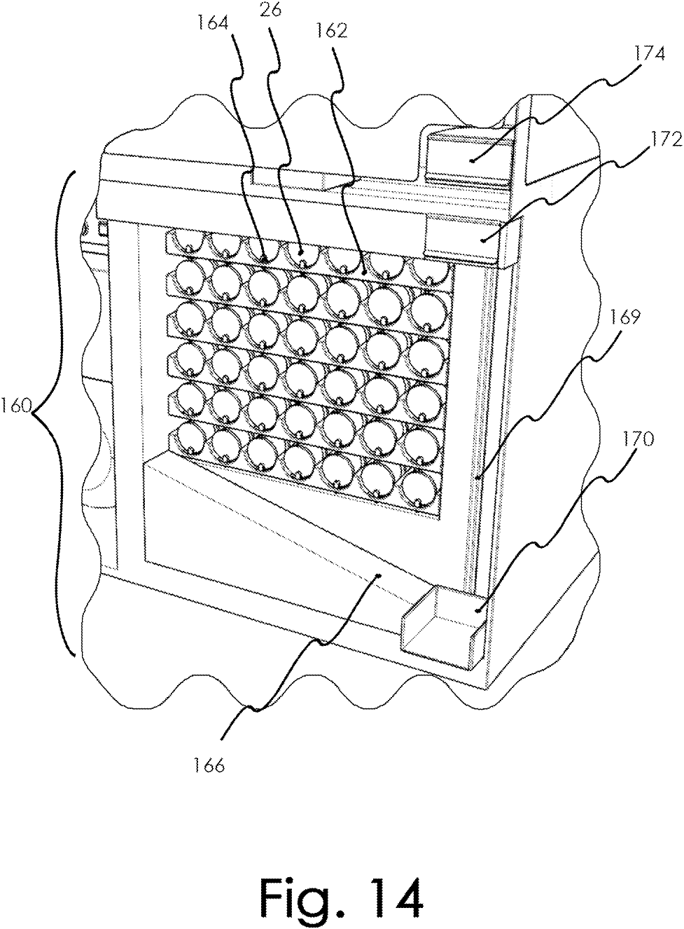

FIG. 14 is a sectioned perspective view of the bottom portion of the carousel assembly. This view clearly shows each column of ice cream cups 26 being retained by four rods 70. One of the rods 70 of each cluster of four has a spring biased plunger to allow the rod 70 to be removed when refilling the carousel with ice cream.

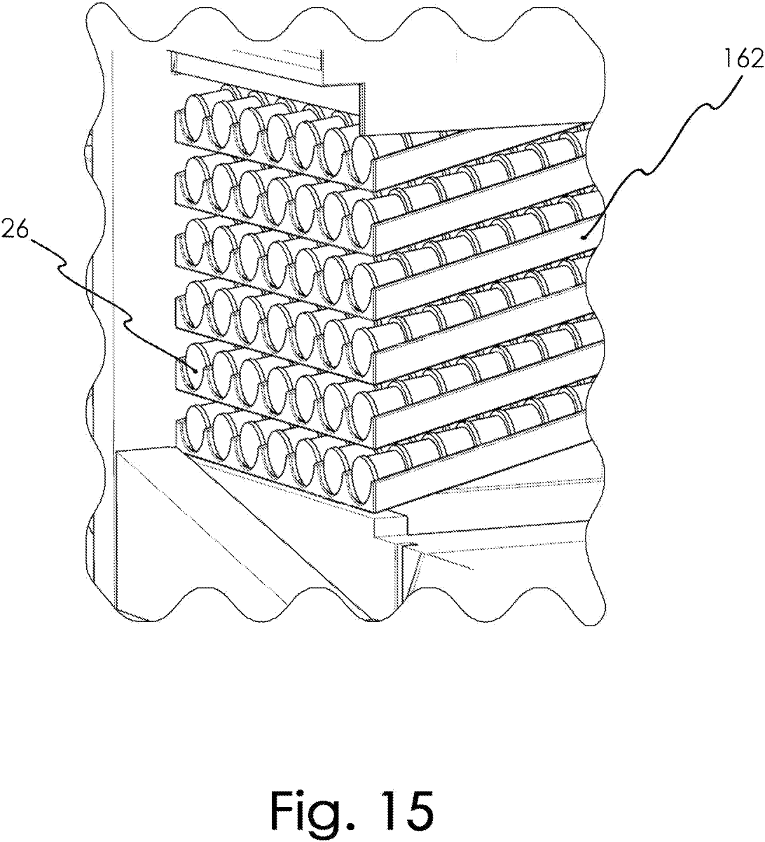

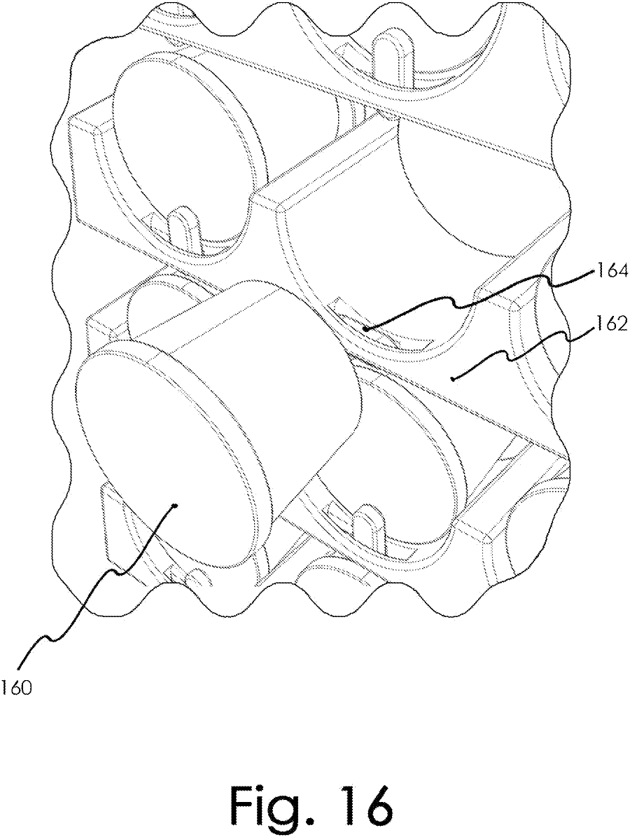

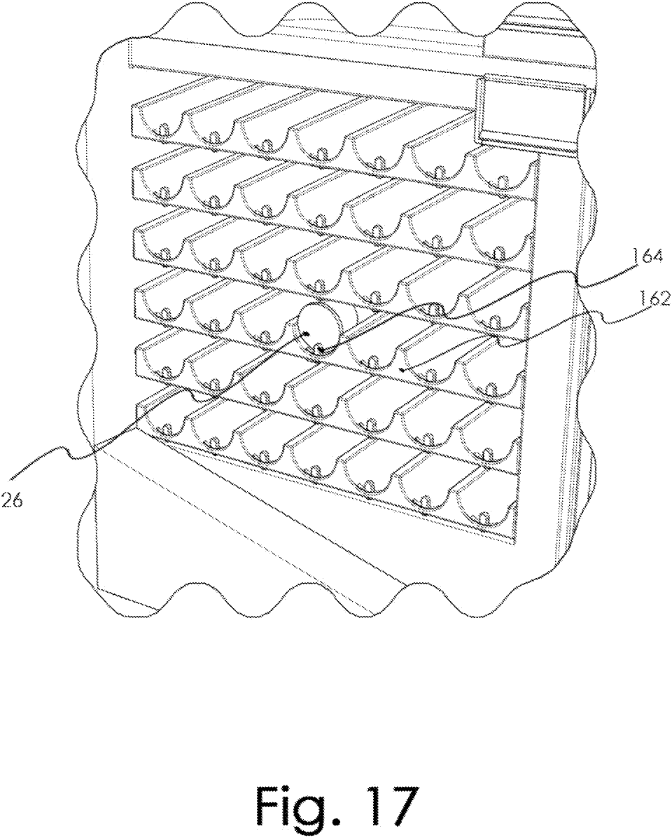

FIG. 15 shows a perspective view of an alternate embodiment of the freezer portion 160 of the invention which employs a multi-shelf 162 design as opposed to the carousel design 90 shown in FIG. 3. The identical shelves 162 are designed to cradle ice cream cups 26 in a plurality of columns. The shelves 162 are angled downward when viewed from the side, as shown in FIG. 16. The angle of the shelves is approximately twenty degrees from horizontal allowing the ice cream cups 26 to slide via gravity when allowed to do so. Each column of cups 26 is held back by a retaining finger 164. At the appropriate time, when the user’s ice cream flavor has been selected and paid for, the retaining finger 164 rotates clockwise ninety degrees as shown in FIG. 17 via a standard servo motor, not shown. The finger 164 rotates counterclockwise ninety degrees as soon as a single cup 26 falls from its shelf, thereby preventing additional cups from being dispensed.

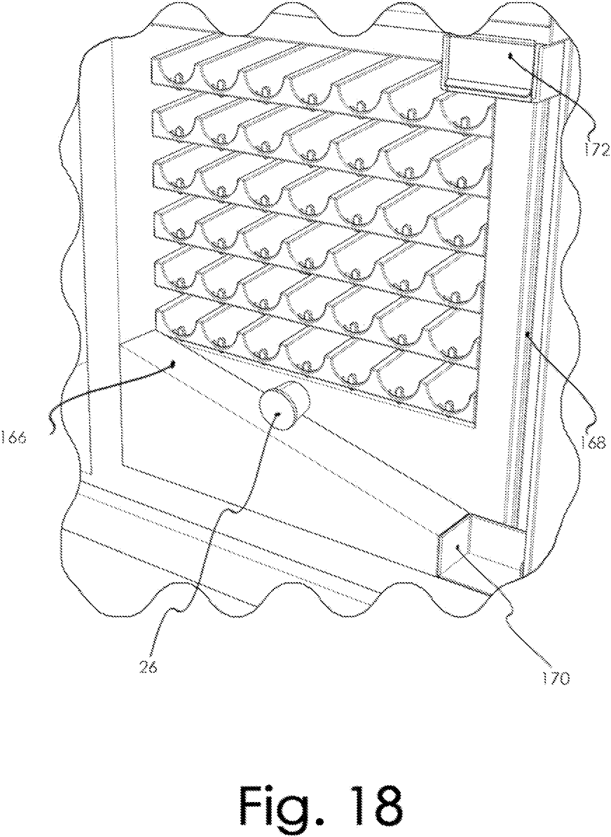

FIG. 18 is a partial perspective view showing one ice cream cup 26 with the remainder of the shelves 162 left blank for clarity purposes.

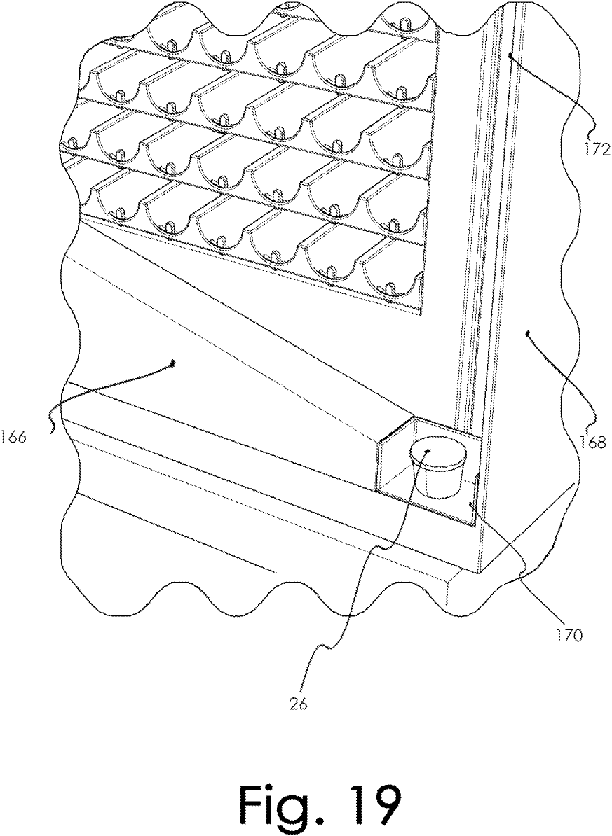

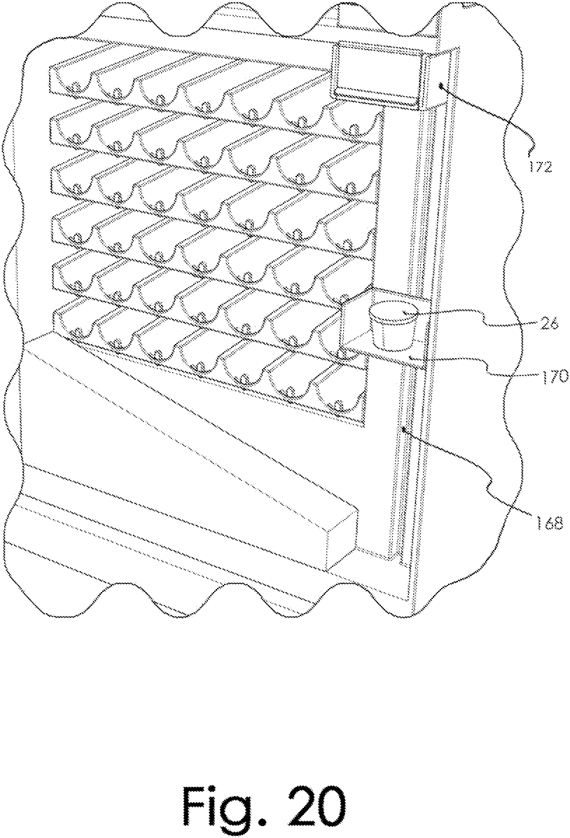

FIG. 19 shows an ice cream cup 26 after it has fallen from its original location shown in FIG. 18. The cup 26 lands on a ramp 166 which causes the cup to roll down via gravity to lift platform 170 as shown in FIG. 20.

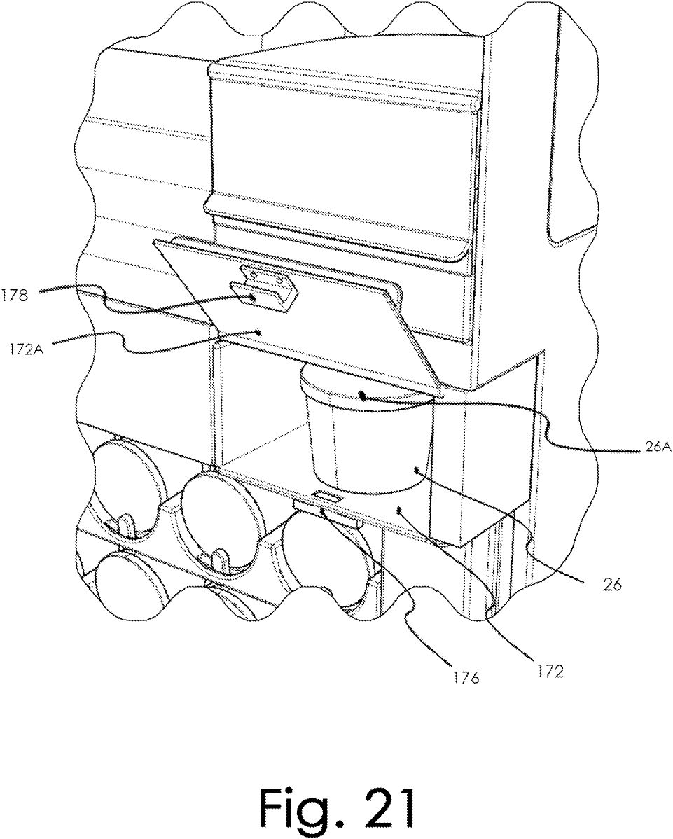

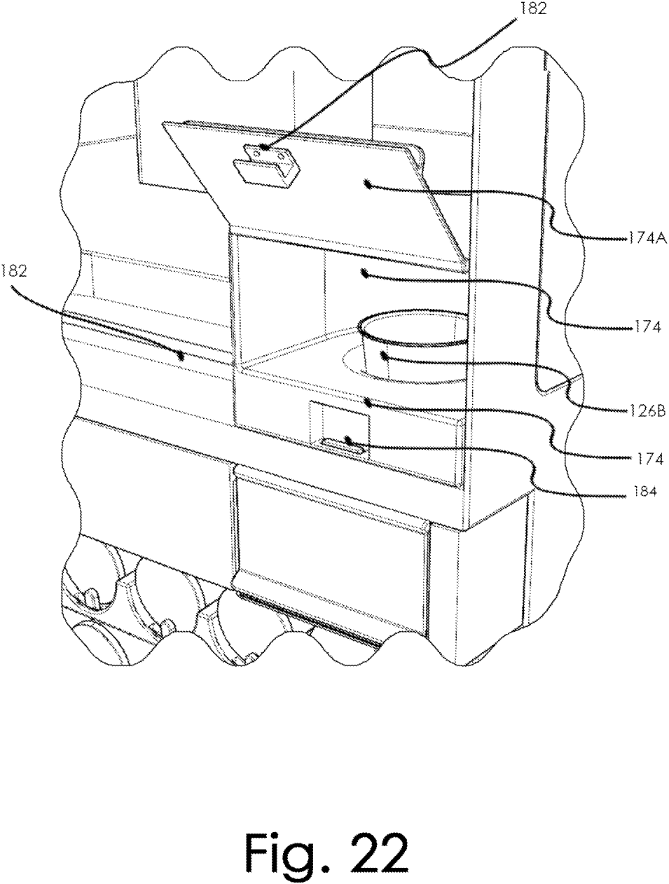

FIG. 21 shows the lift platform 170 being lifted via a standard linear actuator track 168 toward lower box 172 as shown in FIG. 22 where the door 172A has been lifted by the user after the locking mechanism 176 has released locking pin 177 from retaining member 178. The user can then remove the ice cream cup 26 and remove the lid 26A.

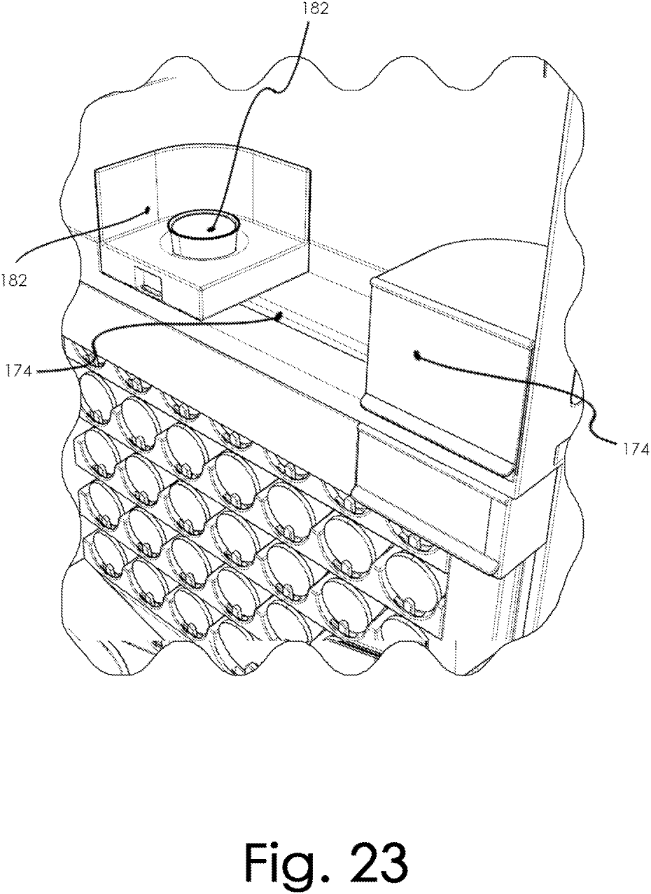

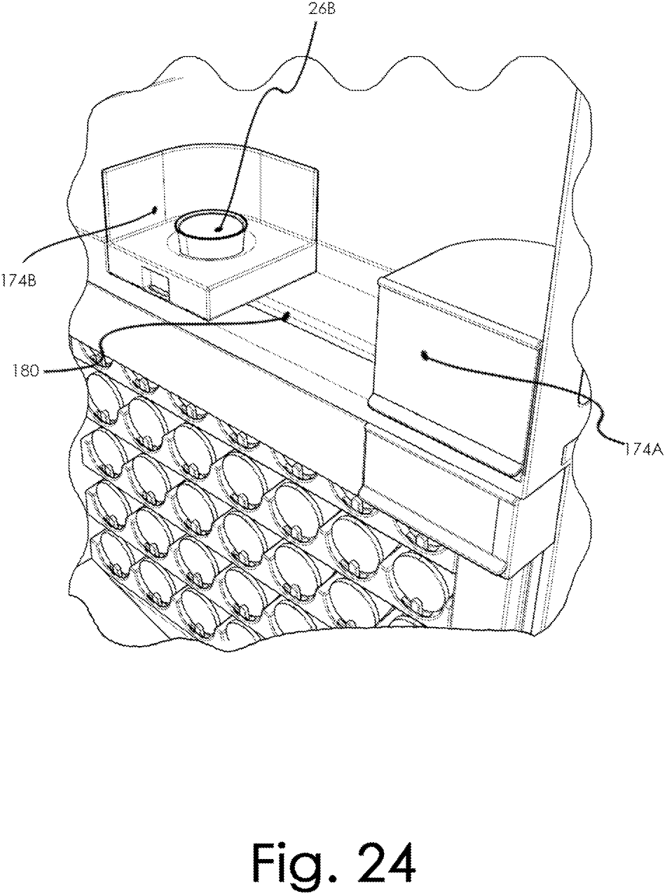

FIG. 23 shows the ice cream cup 26B placed in upper box 174 after door 174A has been opened via the release of a locking post from tab 182. The upper box portion 174B can then be slid to the left via linear actuator assembly 180 so that the upper box portion 174B ends up centrally located within the toppings enclosure, as shown in FIG. 24, enabling toppings to be applied to the ice cream as described in the original embodiment shown in FIGS. 4 and 5.

FIG. 24 shows a portion of the upper box 174B slid to the center of the topping dispensing area so that toppings can be applied into cup 26B. After the toppings have been applied, the upper box portion 174B is then slid to the right where the user can open door 174A to remove the completed ice cream cup 26A with toppings applied. The door 174A to upper box 174 is then automatically closed via spring action and the entire ice cream dispensing device of the present invention is ready to be used by the next user.

The customer use experience is as follows: The customer presses a central graphic button on the touch screen 14. A graphic on the touch screen asks the customer to choose from a plurality of ice cream flavors. Then the touch screen 14 asks the customer to choose one or more hard toppings by pressing on graphic buttons that are associated with each topping. Then the customer is asked to choose from a plurality of liquid toppings by touching graphic buttons that are associated with each liquid topping. Then the customer is asked to pay for the ice cream and toppings via the payment module located at the front of enclosure 2. After payment, the sliding door 44 opens and the selected ice cream cup rises from the freezer enclosure 6. The rotating front door then opens allowing the customer to remove the cup of ice cream and remove the lid of the ice cream cup and then replace the cup inside the topping’s enclosure, a photo sensor will determine whether the ice cream has been removed and replaced. Then the selected liquid toppings are dispensed, and then the selected hard toppings are dispensed. Ideally the liquid toppings are dispensed first so that when the hard toppings are dropped onto the liquid topping, the liquid would help prevent the hard toppings from bouncing out of the cup 26. However, it should be noted that the opposite sequence of events may be more ideal from a user standpoint, and the hard toppings may be dispensed first, and the liquid toppings dispensed second. Finally, the rotating front door opens and allows the customer to remove the finished ice cream treat. Upon removal, the sliding door closes and the rotating door also revolves to the closed position to wait for the next customer. The process of selecting ice cream and toppings may also be facilitated by a phone app. Additionally, the amount of ice cream and toppings stored within the invention at any time may be sensed by visual sensors located throughout the machine and transmitted to a service person at a remote location via Wi-Fi. If there is a malfunction of any of the electro mechanical features or of the compressor and condenser used to keep the freezer enclosure cold, the entire machine 100 will become inactive, and any attempt by a customer to operate the machine 100 will be unsuccessful until the machine 100s brought back to proper working order.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

In the claims, the word ‘comprising’ does not exclude the presence of other elements or steps then those listed in a claim. Furthermore, the terms “a” or “an,” as used herein, are defined as “one, or more than one.” Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are arbitrarily used to distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

What is claimed is:

1. An interactive frozen confectionery vending machine configured to interactively provide a customer with a selection from a plurality of flavors of frozen confectionery cups, the frozen confectionary cups comprising a customer removable lid, and with a selection from a plurality of toppings, said interactive frozen confectionery vending machine comprising at least three major enclosures:
a support equipment enclosure;
a freezer enclosure located next to the support equipment enclosure;
a delivery and toppings dispensing enclosure located next to the support equipment enclosure above the freezer enclosure;
walls enclosing interiors of the major enclosures, said walls comprising a plurality of openings among the major enclosures;
a plurality of liquid topping canisters, a bottom of each liquid topping canister comprising a pump connected to a flexible liquid topping delivery tube;
said plurality of each flexible liquid topping delivery tubes tube configured to deliver a liquid topping to a vertically rotatable liquid topping dispensing arm;
a plurality of hard topping canisters, said hard topping canisters radially disposed in the delivery and toppings dispensing enclosure, a bottom of each hard topping canister comprising an opening, further comprising a rotatable gate able to rotate to a position wherein said opening is closed and be able to rotate to a position wherein the opening is open; said rotatable gate further comprising a rotatable knob;
a rotatable hard topping dispensing arm centrally disposed in the delivery and toppings dispensing enclosure;
an access to a frozen confectionery toppings dispensing platform;
a payment system;
a control system comprising a programable digital control processing unit;
a touch screen comprising information input means, the touch screen further comprising output means, wherein said input means and said output means provide means for communication between the customer, the programable digital control processing unit and the payment system; and
the programable digital control processing unit configured to sequence dispensing of the customer selected frozen confectionery cup, dispensing of the customer selected liquid toppings and dispensing of the customer selected hard toppings.

2. The interactive frozen confectionery vending machine of claim 1 wherein each flexible liquid topping tube is terminated with a non-drip spring biased exit port.

3. The interactive frozen confectionery vending machine of claim 1 wherein the rotatable liquid topping dispensing arm comprises means for rotating said rotatable liquid topping dispensing arm in a vertical plane, said liquid topping dispensing arm being lowered to dispense a selected liquid topping and the liquid topping dispensing arm being raised after said liquid topping dispensing is completed.

4. The interactive frozen confectionery vending machine of claim 1 wherein the rotatable hard toppings dispensing arm further comprises:
a motor end, wherein said motor end comprises motor means to drive the arm to the selected hard topping canister rotatable gate and to the frozen confectionery cup disposed on the toppings dispensing platform;
a distal end, wherein said distal end comprises motor means to rotate the hard topping canister rotatable gate knob; and
the distal end further comprising a rotatable cup and motor means to rotate said rotatable cup.

5. The interactive frozen confectionery vending machine of claim 1 further comprising a plurality of backlit photo panels, wherein each of the photo panel corresponds to one of the liquid topping canisters, wherein each photo panel lights up intermittently when the corresponding liquid canister is dispensing.

6. The interactive frozen confectionery vending machine of claim 1 further comprising a video display panel, wherein said video display panel is capable of displaying animated images.

7. The interactive frozen confectionery vending machine of claim 1 further comprising a utensil dispenser.

8. The interactive frozen confectionery vending machine of claim 1 wherein the toppings delivery enclosure further comprises a front door and a side wall panel, wherein said front door and said side wall panel are transparent.

9. The interactive frozen confectionery vending machine of claim 1, wherein the vending machine is in an initial waiting state expecting a customer initiated sequence of steps, wherein the sequence of steps is initiated by the customer interacting with the interactive frozen confectionery vending machine, wherein said sequence of steps comprises:
a. the customer initiates a frozen confectionery purchase by using the touch screen;
b. the customer is prompted to select the frozen confectionery flavor and the hard topping and the liquid topping;
c. the customer is prompted to pay for the selections using the payment system;
d. the frozen confectionery cup customer access is enabled;
e. the customer removes the frozen confectionery cup lid and replaces the frozen confectionery cup on the slidable cup retaining platform; the customer access closes;
f. the selected liquid topping and the selected hard topping are dispensed;
g. the customer access opens;
h. the customer removes the frozen confectionery cup with the topping of the customer’s choice; and
i. the customer access closes, and the interactive frozen confectionery vending machine is returned to the initial waiting state.

10. The interactive frozen confectionery vending machine of claim 1, wherein the freezer enclosure comprises:
a rotatable carousel configured to support multiple stacks of frozen confectionery cups;
a plurality of cup liftable platforms, each cup liftable platform configured to lift one stack of frozen confectionery cups;
a cup liftable platform lifting mechanism;
the rotatable carousel comprising a periphery, wherein the multiple stacks of frozen confectionery cups are radially evenly distributed on said periphery of the rotatable carousel;
each stack of frozen confectionery cups surrounded by a group of at least four rods, wherein at least one rod of the group of at least four rods is removable to enable access to the stack of frozen confectionery cups surrounded by said rods;
the carousel being rotatable to align the selected flavor of frozen confectionery cups with said lifting platform;
a ceiling, comprising an aperture is disposed on said freezer enclosure ceiling;
the aperture disposed on said freezer enclosure ceiling vertically aligned with an aperture disposed in a delivery and toppings dispensing enclosure floor; and
the lifting platform aligned with a slidable cup retaining platform of the access to the frozen confectionery toppings dispensing platform.

12. The interactive frozen confectionery vending machine of claim 1, wherein the freezer enclosure comprises:
a plurality of forwardly angled shelves capable of slidably retaining columns of ice cream cups; said forward most cup being retained by an electro-mechanically rotatable retaining finger;
wherein selection of the selected flavor of the frozen confectionery cup causes the electro-mechanically rotating finger to release the forward most cup, from said column, the cup falls until it contacts a downward sloping ramp and slides down said ramp to a lift platform;
whereupon said cup and said lift platform is lifted via a linear actuator to a lower box enclosure disposed in said freezer enclosure; said lower box enclosure having a lockable front door that unlocks when said ice cream cup is located within said lower box allowing a user to remove said ice cream cup and removed said cup’s lid;
the user can insert said ice cream into the access to a frozen confectionery toppings dispensing platform, the access comprising a front door disposed in an upper box located at the right, front side of toppings dispensing enclosure;
whereupon a sliding portion of said upper box which supports said ice cream cup can slide horizontally to a central area of said toppings dispensing enclosure allowing for dispensing of said hard and liquid toppings to take place as described in claim 1;
wherein after the desired toppings have been delivered, the sliding portion of said upper box slides back to enable the customer to access and remove the selected ice cream cup with the selected toppings.
